(19) United States
(12) Patent Application Publication
(10) Pub. No.: US 2017/0147042 A1
(43) Pub. Date: May 25, 2017

(54) Storage Array Having Multi-Drive Sled Assembly

(71) Applicant: Nimble Storage, Inc., San Jose, CA (US)

(72) Inventors: Chun Liu, San Jose, CA (US); Thomas P. McKnight, San Jose, CA (US)

(21) Appl. No.: 14/949,837

(22) Filed: Nov. 23, 2015

(51) Int. Cl. G06F 1/18; G11B 33/02

(52) U.S. Cl. CPC G06F 1/187; G11B 33/02

(57) ABSTRACT

A sled assembly for a storage array is disclosed. One example of the sled assembly includes a first rail extending between a first end and a second end and a second rail extending between the first end and the second end. The second rail is parallel to the first rail. Further included is an ejector body that is coupled to the first rail and the second rail at the first end. A first drive guide having a first pair of channels is provided. The first drive guide is disposed adjacent to and parallel to the first rail and interfaced with the ejector body at the first end. A second drive guide having a second pair of channels is further provided. The second drive guide is disposed adjacent to and parallel to the second rail and interfaced with the ejector body at the first end. A first drive and a second drive are configured to be disposed between the first rail and the second rail and respectively enabled to slide into and out of the sled assembly. The sled assembly is further configured for sliding into and out of the storage array. The first drive and the second drive are each configured for independent insertion or removal into and out of the sled assembly without removal of the sled assembly from the storage array.

### FIELD OF THE DISCLOSURE

The embodiments described in this disclosure relate to storage systems, and in particular, storage systems with sled assemblies that enable multiple internal drives to be grouped into a single sled assembly, and said sled assemblies enabling independent removal of any one of the multiple internal drives or removal of any internal drive present in the sled assembly together.

### BACKGROUND

Storage arrays are computer systems that are designed to store data and efficiently serve data to processing applications. Typically, storage arrays are provisioned for entities that require specific storage capacity and performance. Often, one or more storage arrays are provisioned for entities having multiple clients, local or remote, that require efficient access to mission critical data. In some configurations, storage arrays are installed in data centers, where multiple storage arrays are clustered together to deliver either higher storage capacity and/or performance.

Although storage arrays work well to provide necessary data storage and performance, components of storage arrays will reach an expected useful end of life. Although other components can fail, e.g., power supplies, processors, etc., storage arrays implement redundancy to account for such failures, whether physical or software related. Most commonly, storage arrays will experience the most stress and wear by the continuous use of hard disk drives (HDDs) and solid state drives (SSDs) that define the storage capacity of the storage array. Given the inherent wear characteristic of HDDs and SSDs, manufacturers of storage arrays understand and indeed program expected end of life for HDDs and SSDs. However, in addition to expected end of life, there are times when HDDs or SSDs fail, either mechanically, physically, or logically. Most storage arrays implement physical redundancy and processes such as redundant array of inexpensive disks (RAID) to protect against such failures. However, once a drive fails, there is still a need to remove and replace such drives. Unfortunately, as the density of drives in storage arrays continues to grow, removal of drives from a storage array can be complicated or time consuming. In some cases, the drive configuration requires that the system be powered down to remove failed drives. In other cases, the drive configuration requires that operating drives be removed together with failed drives. In either of these cases, replacement of failed drives in storage arrays can impose significant time burdens upon storage array technicians and in some cases, can also impact access to data if the storage array is powered down.

It is in this context that embodiments of this disclosure arise.

### SUMMARY

Embodiments are provided that enable efficient insertion and removal of internal drives, in storage arrays. In one configuration, a sled assembly is provided with capacity for internal drives. The sled assembly, holding one or two internal drives can be installed into a storage array and connected to the storage controller as one unit. Further, the sled assembly is configured to enable independent insertion and removal of internal dives, without removal of the sled assembly from the storage array. In one configuration, the sled assembly includes an ejector body disposed as a front plate of the ejector body, provides a button that enables removal or insertion locking of the sled assembly out of or into the storage array. The ejector body, in one configuration, further includes front slots that can independently receive two internal drive assemblies. The ejector body includes an ejector handle that pivots on a hinge of the ejector body. When the button on the ejector body is activated, the ejector handle enables release of the sled assembly from a compartment of the storage array. Independent from the insertion and the removal of the sled assembly from the storage array, internal drive assemblies are capable of being inserted into the front slots of the ejector body, leading into the sled assembly. In one configuration, an internal drive assembly will have one internal drive. Thus, the sled assembly can receive two internal drive assemblies. Thus, if replacement of one drive is required, either to add a drive to increase storage capacity, replace a drive that may be reaching end of life or replace a failed drive, that one drive can be removed and/or inserted into the sled assembly without operational disruption to the other drive, if present, or requirement to pull out the sled assembly.

In one embodiment, a sled assembly for a storage array is provided. The sled assembly includes a first rail extending between a first end and a second end and a second rail extending between the first end and the second end. The second rail is parallel to the first rail. Further included is an ejector body that is coupled to the first rail and the second rail at the first end. A first drive guide having a first pair of channels is provided. The first drive guide is disposed adjacent to and parallel to the first rail and interfaced with the ejector body at the first end. A second drive guide having a second pair of channels is further provided. The second drive guide is disposed adjacent to and parallel to the second rail and interfaced with the ejector body at the first end. A first drive and a second drive are configured to be disposed between the first rail and the second rail and respectively enabled to slide into and out of the sled assembly. The sled assembly is further configured for sliding into and out of the storage array. The first drive and the second drive are each configured for independent insertion or removal into and out of the sled assembly without removal of the sled assembly from the storage array.

In another embodiment, a sled assembly for a storage array is disclosed. The sled assembly includes a first rail extending between a first end and a second end and a second rail extending between the first end and the second end. Further, an ejector body is coupled to the first rail and the second rail at the first end. A first drive guide has a first pair of channels, and the first drive guide is disposed adjacent to and parallel to the first rail and interfaced with the ejector body at the first end. A second drive guide has a second pair of channels, and the second drive guide is disposed adjacent to and parallel to the second rail and interfaced with the ejector body at the first end. A first internal drive assembly for receiving a first drive and a second internal drive assembly for receiving a second drive are provided. Each of said first and second internal drive assemblies include a first sub-rail and a second sub-rail disposed parallel to the first sub-rail, a sub-ejector body coupled to the first and second sub-rails, and a frame base. Further, each of said first and second internal drive assemblies are configured to slide in and out of the sled assembly independent of removal of said sled assembly from said storage array.

In yet another embodiment, a sled assembly for a storage array is disclosed. The storage array includes a first rail extending between a first end and a second end and a second rail extending between the first end and the second end. An ejector body is coupled to the first rail and the second rail at the first end. A first internal drive assembly for receiving a first drive, and a second internal drive assembly for receiving a second drive. Each of said first and second internal drive assemblies include a first sub-rail and a second sub-rail disposed parallel to the first sub-rail, a sub-ejector body coupled to the first and second sub-rails, and a frame base. Further included is a paddle card disposed between the first rail and the second rail. The paddle card has an internal side facing toward the first end and an external side facing toward the second end. A first sled connector is disposed on the internal side of the paddle card, and a second sled connector is disposed on the internal side of the paddle card. The second sled connector is parallel to the first sled connector. The first and second sled connectors provide connection to drive connectors of the first and second drives when disposed in the sled assembly, and a third sled connector is disposed on the external side of the paddle card. The third connector providing an interface for the sled assembly with a connector of a storage controller of the storage array. Each of said first and second internal drive assemblies are configured to slide in and out of the sled assembly independent of removal of said sled assembly from said storage array.

### BRIEF DESCRIPTION OF THE DRAWINGS

FIG. 1A illustrates a cross-sectional view of a storage array, with one sled assembly 100 inserted into a slot of the storage array, in accordance with one embodiment.

FIGS. 1B and 1C illustrates the flexibility which allows for independent removal of internal drive assemblies while the sled assembly remains installed in the storage array, in accordance with one embodiment.

FIG. 1D illustrates an example paddle board, and associated electronics for enabling the connections and bridging functions between protocols, in accordance with one embodiment.

FIG. 1E illustrates an example of a paddle board that uses a non-volatile express (NVME) protocol, instead of the SAS and SATA protocols, in accordance with another embodiment.

FIG. 2A illustrates a three-dimensional view of the side of the sled assembly, in accordance with one embodiment.

FIG. 2B illustrates a three-dimensional view of the internal drive assembly, in accordance with one embodiment.

FIG. 3A illustrates a three-dimensional view of the sled assembly which includes two internal drive assemblies inserted therein, in accordance with one embodiment of the present invention.

FIG. 3B illustrates a three-dimensional view of the sled assembly having internal drive assembly in a slide-out configuration, such as just after being removed or upon being inserted.

FIG. 4A illustrates a three-dimensional front view of the sled assembly having internal drive assemblies without SSD drives, for purposes of illustration of one embodiment.

FIG. 4B illustrates the view of FIG. 4A, with one internal drive assembly in the open or out position, for purposes of illustration of one embodiment.

FIGS. 5A and 5B illustrates configurations of the sled assembly integrated into a storage array, in accordance with example embodiment.

FIGS. 6A and 6B illustrate three-dimensional views of storage arrays having the sled assembly disclosed herein, in accordance with example embodiment

### DETAILED DESCRIPTION

The disclosed embodiments relate to sled assemblies usable to insert and remove hard disk drives (HDDs) and/or solid state drivers (SSDs) from storage arrays, used for storing and serving data used by executing applications. The storage arrays may be used as primary storage for small entities, or may be part of data centers of varying sizes. The sled assemblies described herein are configured for insertion into standard slots sizes used by 3.5 in HDDs. In one embodiment, the sled assembly includes an ejector body that enables two separate 2.5 in internal SSDs to be inserted independently into a same form factor of the 3.5 in HDD.

In one configuration, the ejector body of the sled assembly has front slots that enable each of two SSDs to be inserted therein, using a respective internal sled assembly. An internal sled assembly will also include a sub-ejector body, and a sub-ejector handle. When the internal sled assembly is inserted in the sled assembly, via a slot in the front face thereof, the SSD is installed and connected via internal connectors integrated with the sled assembly. In one configuration, the sled assembly includes two internal connectors for coupling to SSD drivers when inserted into the sled assembly and one external connector that enables connection of the sled assembly to a backplane or connection to a controller of the storage array. Integrated with the sled assembly is a paddle board that includes a bridge chip for enabling translation between communication protocols used by the SSD drives and the back plane connector of the sled assembly.

By way of example, one communication protocol may be a serial attached SCSI (SAS) protocol and another protocol may be a serial AT attachment (SATA) protocol. As will be described in greater detail below, the sled assembly having the ejector body with front slots enables independent and efficient insertion and removal of internal sled assemblies, without requiring the removal of the sled assembly from the storage array. Further, the front face of the sled assembly, when installed in a storage array efficiently and ergonomically exposes quick access to remove the entire sled assembly, while holding any drive disposed therein, or separate removal of any drive disposed therein from its internal slots, without operationally disturbing another drive that may be connected in an operational state. Still further, the independent insertion and removal functionality of the internal sled assemblies from the sled assembly introduces additional efficiencies related to drive maintenance and/or replacement. In some embodiments, when internal drives, e.g., SSDs need replacement on some schedule, each drive in a single sled assembly may be removed and replaced, with minimal system disruption and with ergonomic ease, as the SSDs can be simply removed by release of a button and handle on the internal sled assembly.

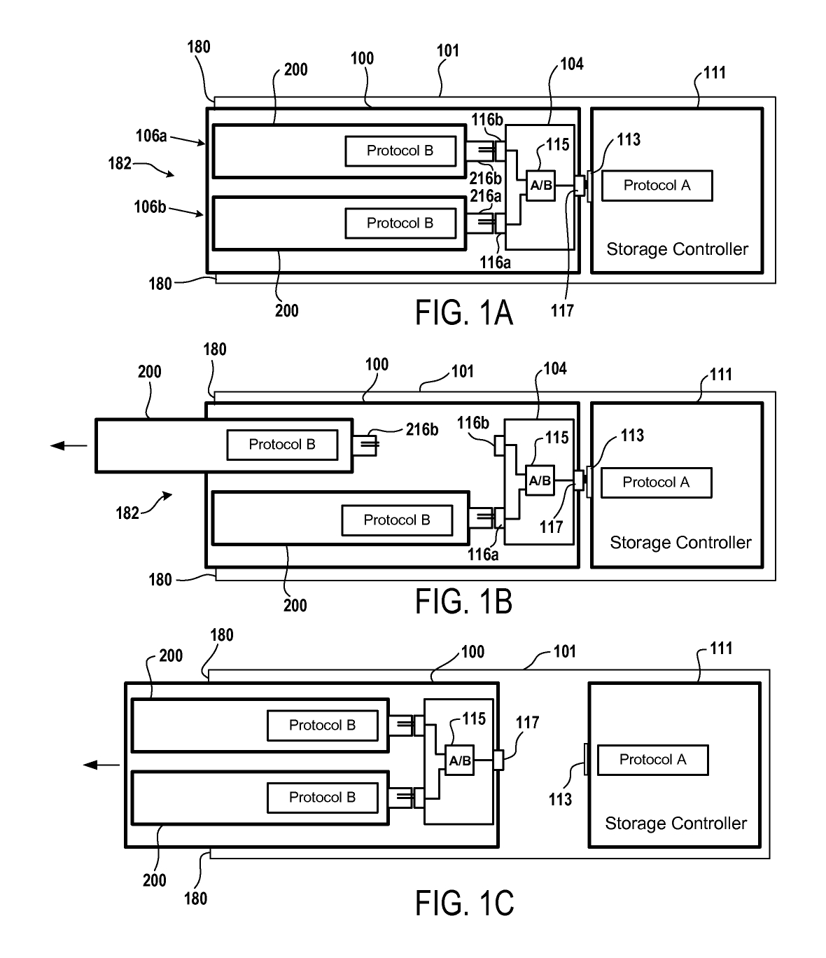

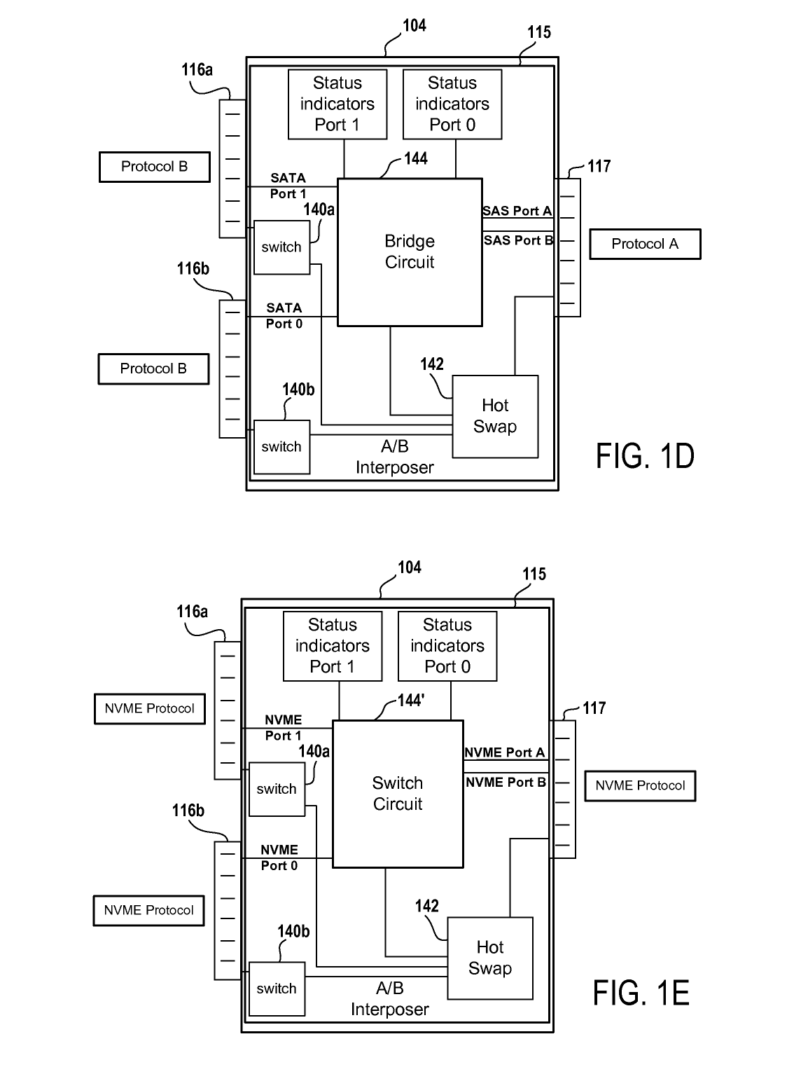

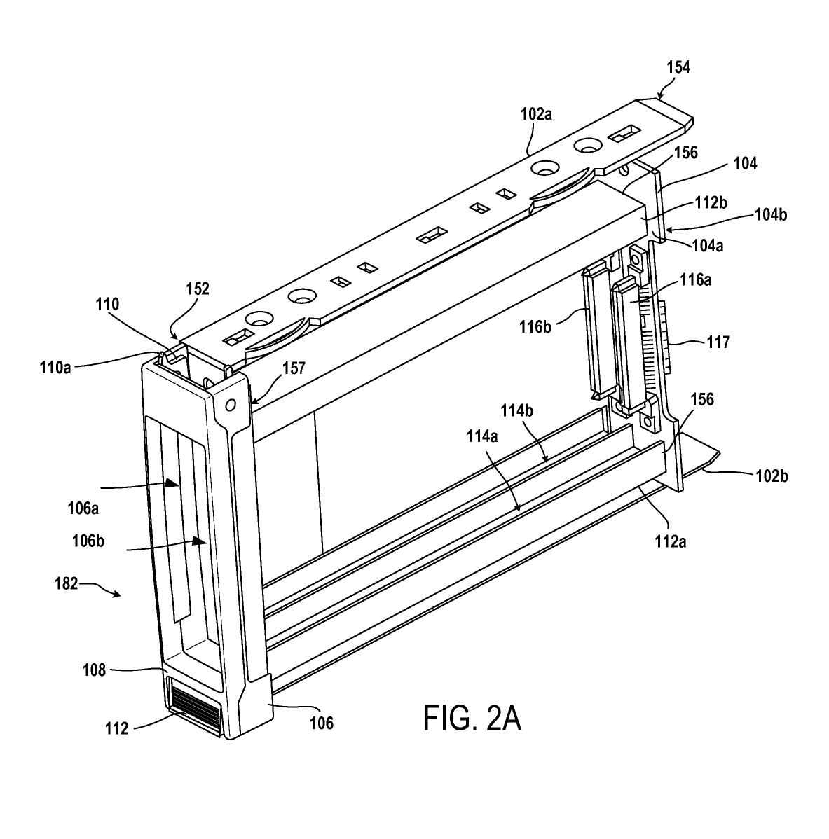

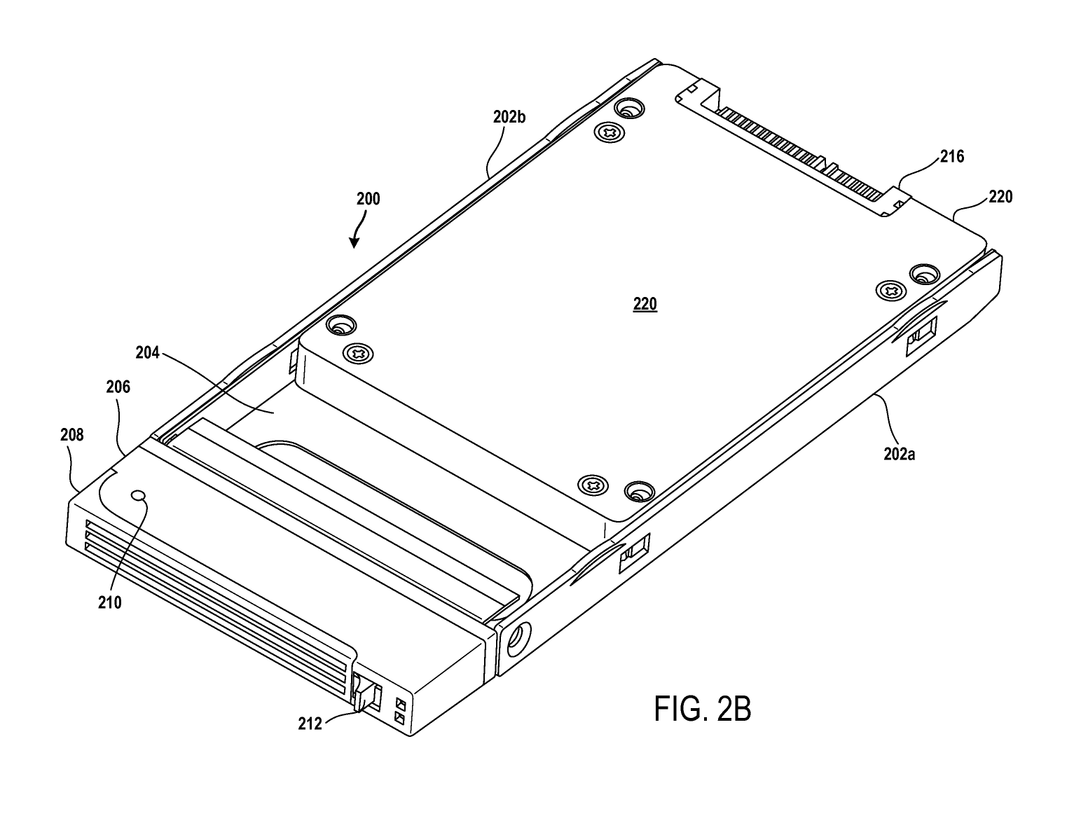

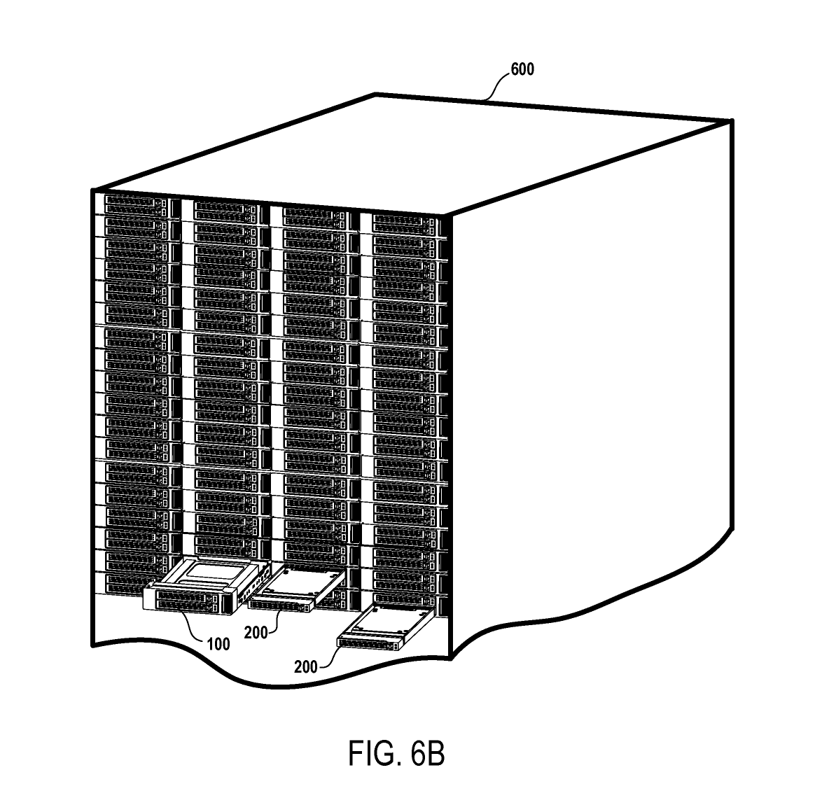

FIG. 1A illustrates a cross-sectional view of a storage array 101, with one sled assembly 100 inserted into a slot of the storage array 101, in accordance with one embodiment. Generally speaking, a storage array 101 is configured to house a plurality of sled assemblies 100, as shown with reference to FIGS. 6A and 6B. FIG. 1A shows that the storage array 101 has a front face 182 in which sled slots 180 are defined. Typically, the sled slots 180 are arranged in rows, depending on the number of rows present in a specific storage array configuration. Commonly, storage arrays have various road dimensions, depending on the implementation. A single row is typically referred to as a 1U form factor, two rows define a 2U form factor, 3 rows define a 3U form factor, 4 rows define a 4U form factor, etc. The illustration provided in FIG. 1A represents a cross-sectional view of a 1U form factor storage array 101. However, if other form factors are used, such as 2U, 3U, 4U, etc., respective sled slots 180 will be defined for each row in which sled assembly 100 is to be inserted. In some conventions, six rows of sled assembly 100 may be referred to as a 4U, based on rack convention). Regardless of the convention nomenclature, any rack height may be used, consisting of any number of rows, wherein each row can have the height of one sled assembly 100, which can hold up to two SSD drives.

In one example, the sled slots 180 are configured to receive standard size 3.5 inch hard drives, and the respective sled assembly. In accordance with one embodiment, the same standard 3.5 inch hard drive sled slot 180 is provided, but each sled assembly 100 will include two internal drive assemblies 200. In one embodiment, a 2.5 inch SSD has a slim form factor. By way of example, some SSDs are about 7 mm thick. In contrast, most commonly used 3.5 inch HDDs, are about 25 mm thick. Volume wise, one 3.5 inch drive is almost 8 times of 2.5 inch drive, i.e., 7 mm drive (386 cm̂3/49 cm̂3=7.8). Thus, it is more than feasible to fit two SSD drives, side-by-side between rails of the sled assembly 100. As technology continues to decrease the size of storage drives, it is envisioned that it would be possible to integrated more than two SSD drives into a single sled assembly 100.

In one configuration, each sled assembly has a front face 182 that includes front slots 106a and 106b. By way of the front slots 106a and 106b, the internal drive assemblies 200 may be inserted into a sled slot 180, allowing the SSD drive house by the internal drive assembly 200 to be provided into the sled assembly 100. As shown, each sled assembly 100 will include SSD drives that function in accordance with a specific protocol, e.g., protocol B. By way of example, protocol B may be a SATA protocol, which has an associated connector configuration and pin arrangement defined by standards. Further shown is a backplane connector 113 that interfaces with the storage controller 111, such that when sled assembly 100 is inserted into the storage array 101, a sled connector 117 mates with the backplane connector 113 of the storage controller 111. In one embodiment, the storage controller interface may utilize protocol A, which by way of example can be a SAS protocol, which has associated connector configurations and pin arrangements defined by standards.

Further shown is first sled connector 116a and second sled connector 116b, which are respectively coupled to drive connectors of the SSD drives housed in the internal drive assemblies 200. Further shown is a paddle card 104 that provides an interface between the internal drive assemblies 200 and the backplane connector 113 of the storage controller 111. In one configuration, the paddle card 104 is defined by a printed circuit board (PBC), which has electronics integrated to enable translation of communication signals between the SSD drives utilizing protocol B and the storage controller 111 utilizing protocol A. As will be described in more detail below, the paddle card 104 is fixed to the sled assembly 100, such that the connectors 116a and 116b stay integrated with the sled assembly 100. Further, the paddle card 104 is configured to include an A/B interposer 115, which includes Bridget circuitry for enabling the communication between the two protocols A/B, and also providing the functional sensing of presence of SSD drives in the sled assembly 100 and interconnection status with the storage controller 111.

FIG. 1B and FIG. 1C illustrates the flexibility which allows for independent removal of internal drive assemblies 200 while the sled assembly 100 remains installed in the storage array 101. FIG. 1B illustrates how internal drive assembly 200 may be removed by sliding out of the front face 182 of the sled assembly 100, while the sled assembly 100 remains installed in the sled slot 180. As shown, the second sled connector 116b is no longer connected to the drive connector 216b, while the other internal drive assembly 200 remains in a connected configuration with the first sled connector 116a. As described with reference to FIGS. 1D and 1E, the communication can, in some examples, between SAS to SATA or NVME to NVME.

FIG. 1C illustrates how the sled assembly 100 may be removed from the sled slots 180 together as a unit, while holding the internal drive assemblies 200 in place, in a connected configuration with the 104 paddle card 104. As further shown, the sled connector 117 is now no longer interconnected with backplane connector 113 of the storage controller 111. In this configuration, the storage controller 111 is integrated in a fixed relationship to the storage array 101, and remains in place when the sled assembly 100 is removed or inserted, causing interconnection between connected 117 and 113. As further shown, the sled assembly 100 is caused to slide out of the sled slots 180, while maintaining the internal drive assemblies 200 in place. It should be understood that a drive assembly 100 can operate with a single internal drive assembly 200 installed, thus having one empty slot available for future expansion. If future expansion requires insertion of another internal drive assembly 200 with another SSD drive, the additional internal drive assembly 200 may be inserted into the sled assembly 100 without disturbing the other SSD drive connected in the sled assembly 100 via the internal drive assembly 200.

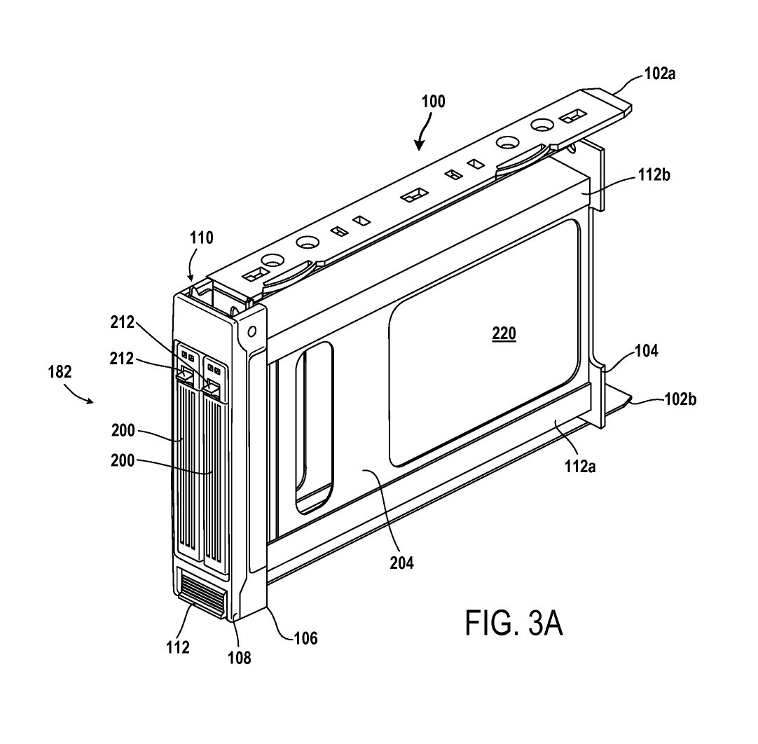

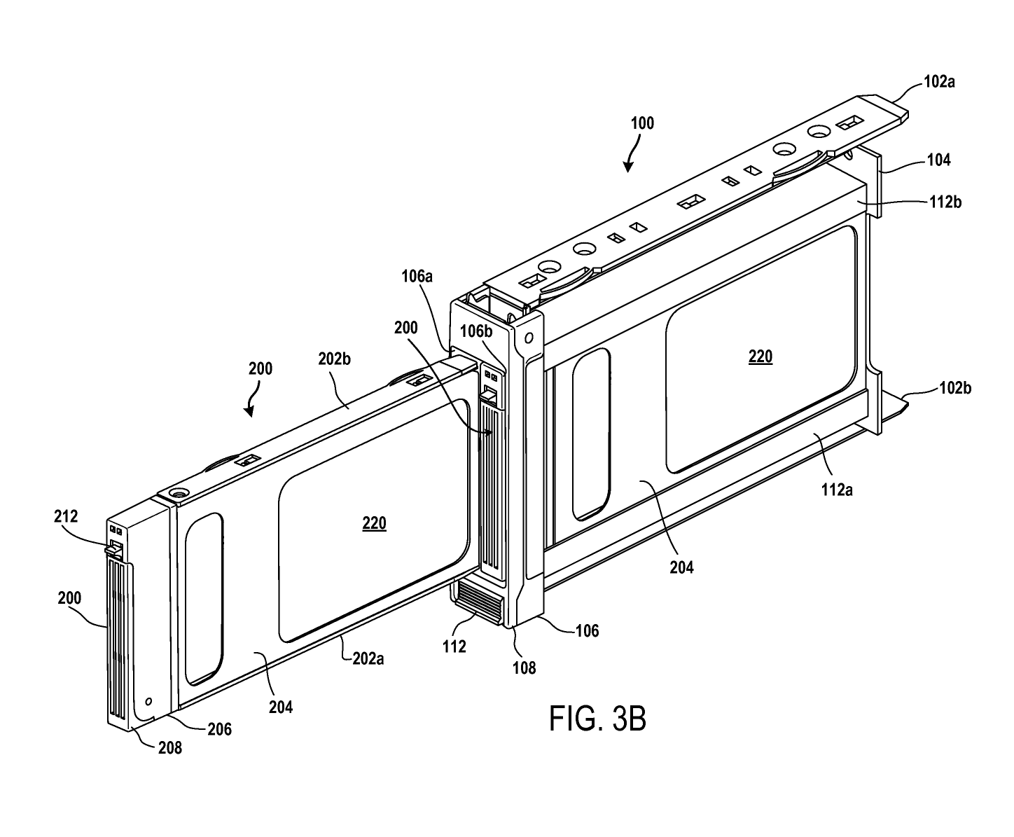

FIG. 1D illustrates an example paddle board 104, and associated electronics for enabling the connections and bridging functions between protocols, in accordance with one embodiment. The paddle board 104 shows the first sled connector 116a and the second sled connector 116b oriented on one side of the paddle board 104. A third sled connector 117 is disposed on the opposite side of the paddle board 104. As will be shown in more detail with reference to FIG. 2A, the paddle board 104 has two sides, namely an internal side with the connectors 116a and 116b, and an external side with the connector 117. A bridge circuit 144 is provided on the paddle board 104, for managing the translation between communication of protocol A and protocol B, and also managing hot-swap 142 detection signals of the connectors. Broadly speaking, the bridge circuit 144 enables translation between communication signals formatted in accordance with the SATA standard and communication signals formatted in accordance with the SAS standard. The bridge circuit 144 is further configured to identify when communication for the SATA port 1 is being received so as to provide communication via the SAS port A, interfaced with the connector 117. In a like manner, communication from the SATA port 0 can be received and then provided to the SAS port B.

The bridging function therefore translates signals propagated between the two protocols, such that communication to and from the SSD drives and the storage controller are in accordance with the standard understood by the controller or SSD drives, respectively. Further, the paddle board 104 also includes switches 140a and 140b, to determine signaling information that identifies when SSD drives are connected to either of the connectors 116a or 116b, so as to provide status data to the hot-swap 142. The hot-swap 142 may also communicate with connector 117, such as to determine when the sled assembly 100 has been removed. As used herein, hot swapping refers to the ability to remove a drive without turning off the system. For example, the sled assembly 100 can be removed from the storage array 101 without having to turn off the storage array 101. In the same form, the individual SSD drives present in the internal drive assembly 200 may be removed from the sled assembly 100, without having to turn off the storage array 101 or other functionality.

Hot-swap 142 therefore provide signaling to the bridge circuit 144, which can also communicate such information to the storage controller 111 of the storage array 101. Still further, the paddle card 104 can include status indicators, which can be used to identify the status of the SSD drives connected to the connectors 116a and 116b. In one embodiment, the status indicators can be used to command that a light be turned on, indicative of the status of the SSD drive. In one embodiment, if the SSD drive is not appropriately connected to the sled assembly 100, a particular color can be identified indicating the same. For example, the light or lights can be integrated on the sub-ejector body 206 of the internal drive assembly 200, such that the light indicators can be visible from the front face 182 of the sled assembly 100.

FIG. 1E illustrates an example of a paddle board that uses a non-volatile express (NVME) protocol, instead of the SAS and SATA protocols, in accordance with another embodiment. The NVME protocol is also referred to by the acronym NVMe. Generally, an NVME protocol is a communications interface developed for SSDs. For example, the NVME protocol is designed to take advantage of the unique properties of pipeline-rich, random access, memory-based storage. In FIG. 1E, a switch 144′ functions as the interface between the connectors 116a and the connector 117.

FIG. 2A illustrates a three-dimensional view of the side of the sled assembly 100, in accordance with one embodiment. In this illustration, the sled assembly 100 is shown to include a rail 102a and a rail 102b, which are parallel to each other and extend between a first end 152 and a second and 154. The second end 154 is the end that is inserted into the sled slots 180 of the storage array 101. The first end 152 is the location where an ejector body 106 couples to the rail 102a and the rail 102b. The ejector body 106 is coupled to an ejector handle 108, which pivots about a hinge 110. When the ejector handle 108 is released or opened by way of activation of a button 112, the ejector handle 108 can be pooled and will prohibit about the hinge 110. As the ejector handle 108 is pooled, a lever 110a of the ejector handle will cause a release of the sled assembly 100 from the sled slots of the storage array 101. In one embodiment, the rails 102 may be made of steel, stainless steel, plastic, molded plastic, carbon fiber, plastic coated metal, fiberglass, etc. One requirement is that the rails 102 provide sufficient rigidity to support and connect to other components of the sled assembly 100 and the internal drive assembly discussed with reference to FIG. 2B.

In one embodiment, the lever 110a is defined by one or more movable metal connectors that apply a force when the ejector handle 108 is opened that also dislodges or pulls the sled assembly 100 out of the sled slot 180. The lever 110a is therefore composed of one or more links that allow for force to occur against a surface of the opening of the sled slot 180, which allows for the dislodging or disengaging of the sled assembly 100 from the sled slot 180, thus disengaging sled connector 117 from the backplane connector 113 of the storage controller 111. As shown, the ejector body 106 also includes a first slot 106a and a second slot 106b at the front face 182 of the sled assembly 100. The first and second slots 106a and 106b provide a pathway for inserting to internal drive assemblies 200 (as shown in FIG. 2B), until the drive connector 216 engages with a respective sled connector 116a or 11b. Further shown is a pair of channels 114a and 114b, wherein each channel is designed to receive one of the internal drive assemblies 200.

For example, when an internal drive assembly 200 is inserted from the front face 182 of this letter assembly 100, the internal drive assembly 200 slides into one of the channels 114 until the drive connector 216 and the respective sled connector 116 of the paddle card 104 mate and engage in functional communication. In one embodiment, the pair of channels 114a and 114b are defined on both of a first drive guide 112a and a second drive guide 112b. As shown, the first drive guide 112a has its channels 114 facing the channels of the second drive guide 112b, such that the internal drive assemblies 200 can fit between respective channels of the parallel and opposing drive guides 112a and 112b.

In one embodiment, the paddle card 104 is coupled to the back ends 156 of the first and second drive guides 112a, and a front end 157 of the drive guides 112a and 112b are coupled to the ejector body 106. In one embodiment, the paddle card 104 holds the back end 156 of the drive guides 112, while the ejector body 106 holds the front ends 157 of the drive guides 112. As shown, the first sled connector 116a is substantially aligned with the first drive guide 112a, while the second sled connector 116b is substantially aligned with the second drive guide 112b. In this manner, when the internal drive assembly 200 is inserted via the front face 182 into the respective front slots 106a and 106b, the drive connector 216 can be guided to mate with the respective sled connector 116.

FIG. 2B illustrates a three-dimensional view of the internal drive assembly 200, in accordance with one embodiment. As shown, the internal drive assembly 200 includes sub-rails 202a and 202a, which are aligned parallel to each other and coupled to the sub-ejector body 206. Also shown is a frame-based 204, which provides rigidity between the sub-rails 202a and 202b. Further, the frame-based 204 provides a surface onto which an SSD drive 220 can be received and held. In one embodiment, the SSD drive 220 will be held in place without mechanical screws or pins, simply by attaching to integrated connectors of the sub-rails 202a and 202b. For example, the integrated connectors can provide a compression connection or can provide a connection by way of integrated connectors being recessed into a side form factor of the SSD drive 220. The integrated connectors can be defined by pins that slide in and out, depressed snaps that allow sliding into and out of recesses, clips that deflect, compression, springs, etc. In an alternative embodiment, screws or other connectors can be used to hold the SSD drive 220 in place on the internal drive assembly 200. Further, in other embodiments, the frame-based 204 may be omitted if the SSD drive 220 is more firmly attached to the sides of the sub-rails 202a and 202b, e.g., using one or more of a tab(s), a clip(s), a recess(s), a protrusion(s), a spring(s), a weld(s), compression, or combinations thereof.

As further shown, the sub-ejector body 206 is integrated with a sub-ejector handle 208. A button 212 may be integrated into the sub-ejector body 206, which can provide for functionality of releasing the sub-ejector handle 208. By releasing the sub-ejector handle 208, the sub-ejector handle 208 may be pulled by a human hand, just as the ejector handle 108 can be pulled by a human hand, so as to cause the pivot about a hinge 210. As the sub-ejector handle 208 is pulled, the pivoting motion will cause a lever action by the sub-ejector body proximate to the sub-ejector handle 208, which enables or facilitates release of the internal drive assembly 200 from the sled assembly 100. In one embodiment, once the sub-ejector handle 208 has been released, this provides a sufficient grip or area by which a user can pull upon the internal drive assembly 200, so as to release it from the sled assembly 100.

As described above, access to the button 212 and the sub-ejector handle 208 of the internal drive assembly 200 can be facilitated from the front face 182 of the sled assembly 100. This provides for an efficient access to either one of the internal drive assemblies 200 that may be inserted at any time in the sled assembly 100. As mentioned above, the insertion or removal of any one of the internal drive assemblies 200 from the sled assembly 100 will be independent of each other, thus removing functional interruption of the sled assembly 100 with the storage controller 111.

In one embodiment, the sub-rails 202 may be made of steel, stainless steel, plastic, molded plastic, carbon fiber, plastic coated metal, fiberglass, etc. One requirement is that the sub-rails 202 provide sufficient rigidity to support and connect to other components of the internal drive assembly 200. In a similar manner, the frame-based 204 may be made from steel, stainless steel, plastic, molded plastic, carbon fiber, plastic coated metal, fiberglass, etc. In some embodiments, components of the sled assembly 100 and/or the internal drive assembly 200 are may be connected using screws, welds, glue, or may be molded into specific forms, shapes, etc. In still other embodiments, some components may maybe made using 3D-digital printers.

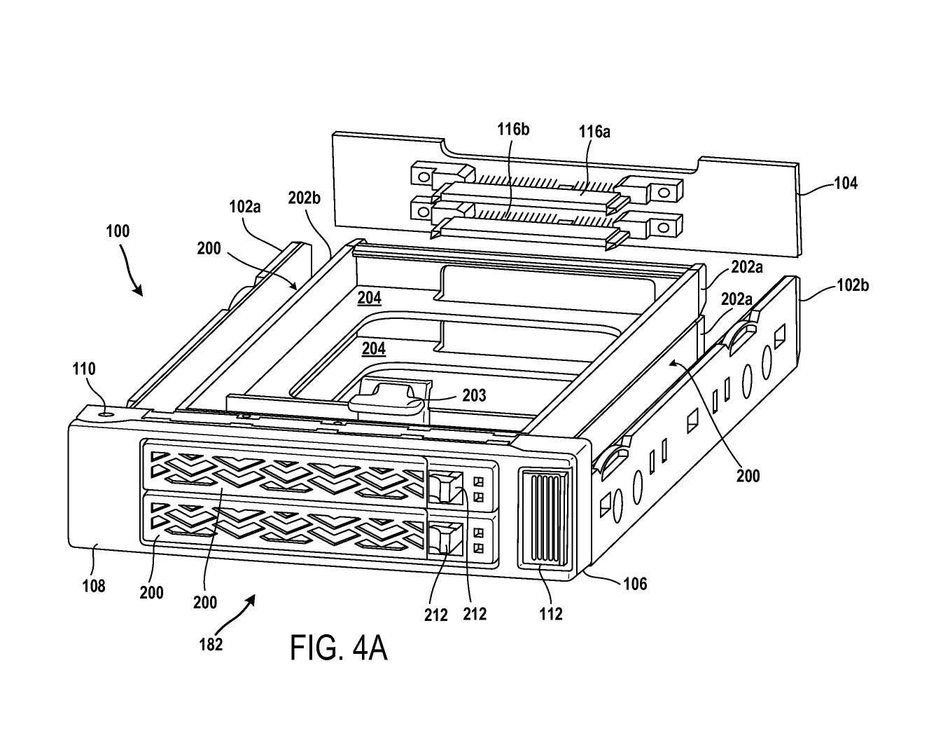

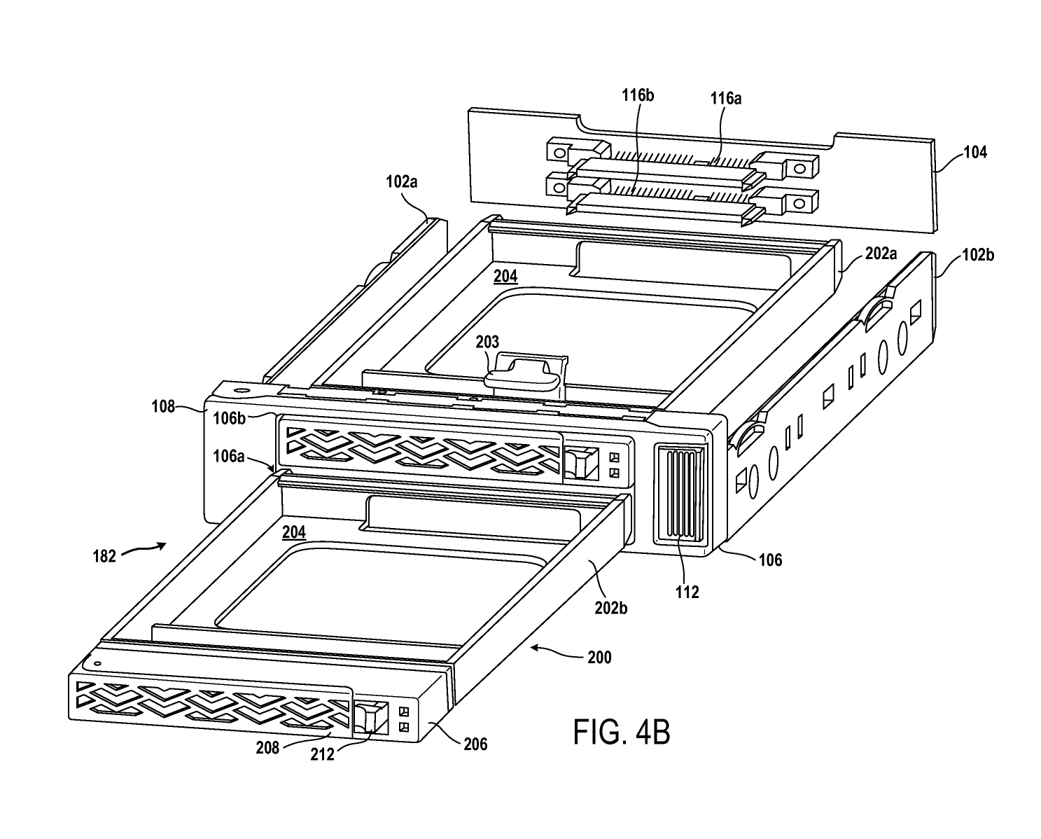

FIG. 3A illustrates a three-dimensional view of the sled assembly 100 which includes two internal drive assemblies 200 inserted therein, in accordance with one embodiment of the present invention. In this illustration, it can be seen that the front face 182 of the sled assembly 100 provides ample access to the buttons 212 of the individual internal drive assemblies 200, as well as the button 112 of the sled assembly 100. When the sled assembly 100 is inserted into the sled slot 180 of the storage array 101, what is visible and accessible to technicians for replacement or insertion is the front face 182. This cross-sectional view also illustrates how the internal drive assembly 200 is held in place by the drive guides 112, which provide connection of the SSD 220 to the paddle card 104, and its associated sled connectors 116.

FIG. 3B illustrates a three-dimensional view of the sled assembly 100 having internal drive assembly 200 in a slide-out configuration, such as just after being removed or upon being inserted. This illustration shows the ease in which the sled assembly 100 can receive insertion or removal of the internal drive assembly 200 into the front slots 106a or 106b.

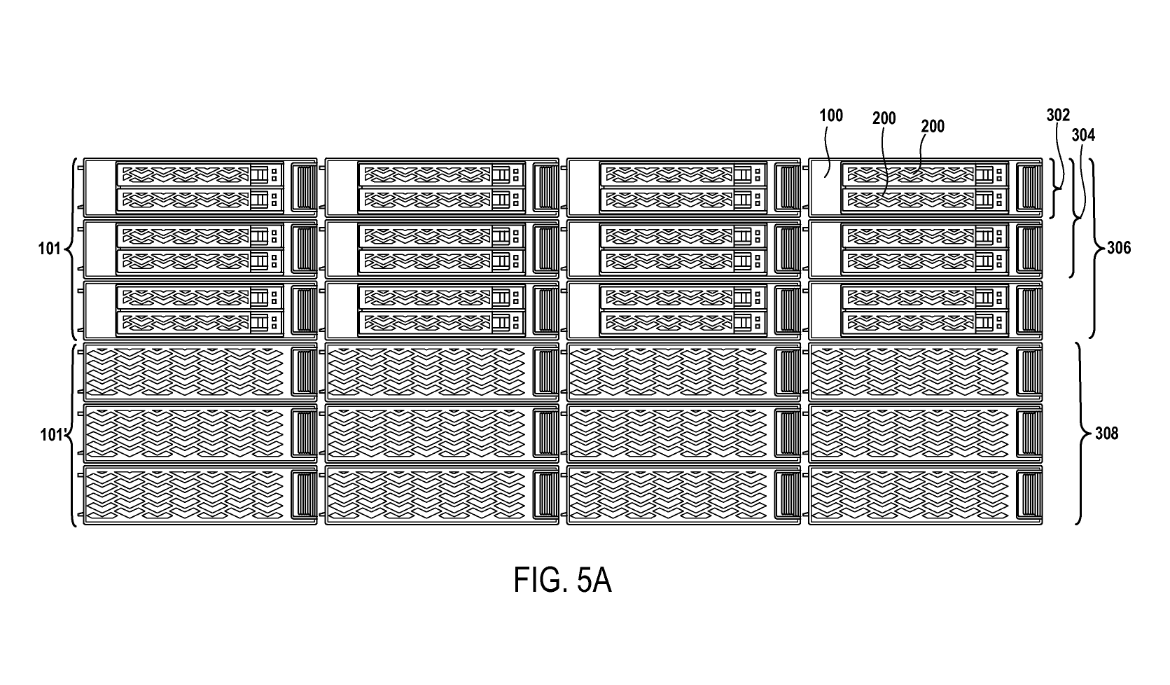

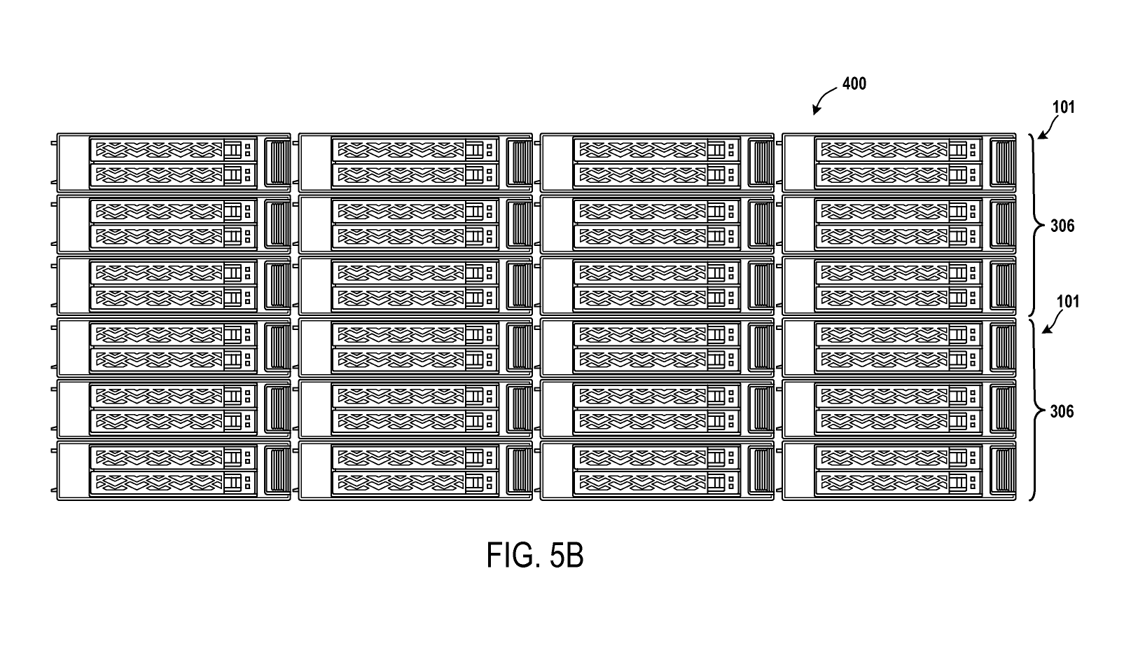

FIG. 4A illustrates a three-dimensional front view of the sled assembly 100 having internal drive assemblies 200 without SSD drives 220 inserted therein, and with the paddle board 104 unattached, for purposes of illustration. A clip 203 is shown, which is used to attach to the SSD drive 220 when present. This clip 203 will remain internal and attached to the internal drive assembly 200, and is flush with the sub-rails 202a and 202b, which allows for the clip to not interfere with exiting or entering the front slots 106a or 106b. The clip 203, in one embodiment, is optional to secure the SSD drive 220 to the internal drive assembly 200. Also not shown are the drive guides 112a and 112b, so as to illustrate internal configurations of the internal drive assembly 200 with respect to the rails 102a and 102, and the ejector body 106.

This configuration shows in alternate arrangement where buttons 212 of the internal drive assemblies 200 are disposed on a same side as the button 112 of the sled assembly 100. This configuration can be accommodated if the sled connectors 116a and 116b are reversed. Therefore, the positioning of the buttons 212 relative to button112 provides flexibility depending upon the desired ergonomics or ease of access. For example, some implementations will benefit from having the buttons 112 further apart from button 112, and vice versa. FIG. 4B illustrates how the internal drive assembly 200 is slid out of the front slot 106b, of the ejector body 106, while the internal drive assembly 200 of the front slot 106a remains inserted. As mentioned above, the clip 203 is optional, and is not shown in the internals drive assembly 200 that is opened.

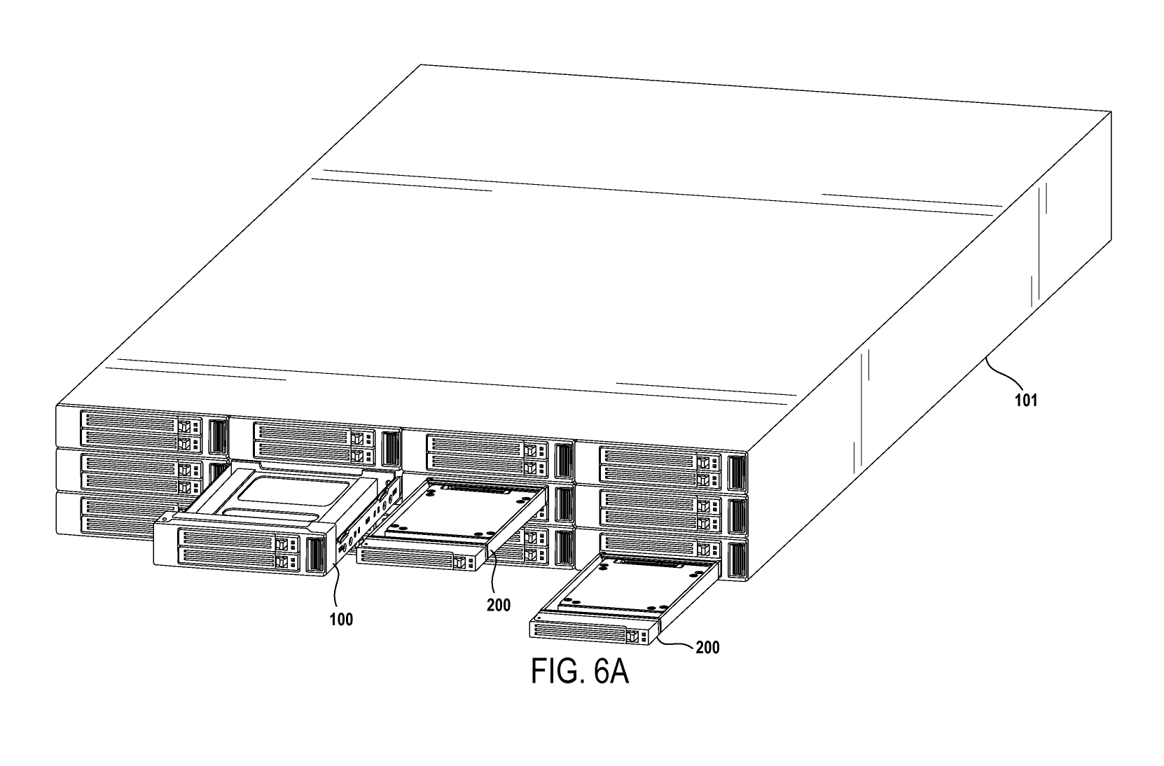

FIG. 5A illustrates an example configuration of sled assembly 100 integrated into a storage array 101 and a storage array 101′, in accordance with one embodiment. In one configuration, the storage array 101 can be defined by single row 302, which would be referred to as a 1U configuration or form factor. In another embodiment, the storage array 101 can be defined by two rows 304, which would be referred to as a 2U configuration or form factor. In still another embodiment, the storage array 101 can be defined by three rows 306, which would be referred to as a 3U configuration or form factor. Thus, a 3U form factor that includes sled assemblies 100 and internal drive assemblies 200 can define a system that has 24 SSD drives.

In some configurations, storage arrays 101 can be designed so that only one of the slots of a sled assembly 100 is occupied with an SSD. For instance, if a storage array has three rows of sled assemblies 100, it is possible that only the top or the bottom SSD is present in each sled assembly 100. Over time, if expansion is needed, e.g., to add more SSD space, the second row can be filled with SSDs.

In other embodiments, it is possible to intentionally leave one slot open in each sled assembly 100. Then, on a schedule, as anticipated wear of the SSDs occurs, the slot that was left open can be filled with an SSD, enabling migration of data from the existing, older SSD, to the new SSD. Once the data has been migrated, e.g., via a hot swap in real-time without taking down the system, the older SSDs can be removed, leaving that slot open. Thus, providing two slots for SSDs in each sled assembly 100 allows for programmatic replacement of SSDs based on anticipated wear life or desire for swap or replace schedule.

The storage array 100′, for example may be defined by twelve HDDs, in arrangement 308. By comparison, twice the amount of drives can be integrated into storage array 101 versus storage array 101′. More significantly, any one of the internal drive assemblies 200 may be inserted or removed from any one of the sled assemblies 100 integrated into the storage array 101, no matter what the chosen form factor is for the storage array configuration. By way of example, FIG. 5B configuration 400 shows two 3U 306 storage arrays 101, which illustrate the modularity of the system.

FIG. 6A illustrates an example three-dimensional view of a storage array 101, having twenty-four internal drive assemblies 200 and twelve sled assemblies 100, in accordance with one embodiment. This illustration also shows the flexibility of allowing individual internal drive assemblies 200 to be independently removed from the storage array 101 without having to remove the sled assembly 100. However, if the sled assembly 100 is removed, both internal drive assemblies 200 will be simultaneously removed from the storage array 101. FIG. 6B illustrates the modularity of having the storage array 101 with a plurality of sled assemblies 100, and the modularity and flexibility of being able to remove individual internal drive assemblies 200 from any one of the sled assemblies 100.

This modularity, as mentioned above, provides for the uninterrupted removal of SSD drives from a storage array, even when a particular sled assembly is not removed and maintains another SSD drive in operational condition. Further, FIG. 6B illustrates the form factor and ergonomic design associated with the front face of the sled assembly 100, which provides for direct frontal access of the individual internal drive assemblies 200 as well as the sled assemblies 100, without disrupting any other sled assemblies or any other internal drive assembly 200 that may be operational within the storage array, or a storage data center 600, such as the one illustrated in FIG. 6B.

One or more processing functions can also be defined by computer readable code on a non-transitory computer readable storage medium. The non-transitory computer readable storage medium is any non-transitory data storage device that can store data, which can thereafter be read by a computer system. For example, the processing operations performed by the A/B interposer 115 may include computer readable code, which is executed. The code can be, in some configurations, embodied in one or more integrated circuit chips that execute instructions of the computer readable code. In some examples, the integrated circuit chips maybe be in the form of general processors or special purpose integrated circuit devices In some cases, the processing may access memory for storage in order to render one or more processing operations.

By way of example, the storage controller 111 of the storage array 101 can include a processor, on or more memory systems and buses for exchanging data when processing storage access operations. In some embodiments, the storage array may include redundant systems, such as an active controller and a standby controller. The active controller operates as the primary computing system for the storage array, while the standby controller is ready to take over during a failover operation. In each case, a controller, e.g., storage controller 111 is configured to interface with connections and electronics of a backplane to interface to the many storage drives of the storage array. In this case, the storage array 101 will include many sled assemblies 100, which of which may include one or two SSD drives. Furthermore, the storage array 101 may be a hybrid system, wherein the both HDDs and SSDs make up the storage capacity of the storage array. These examples are simply provided to illustrate the integrated computing nature of a storage array and the tight interchange needed with drives, e.g., HDDs and SSD, which forms the physical storage of the storage array. Still further, other examples of non-transitory computer readable storage medium include hard drives, network attached storage (NAS), read-only memory, random-access memory, CD-ROMs, CD-Rs, CD-RWs, magnetic tapes and other optical and non-optical data storage devices. The non-transitory computer readable storage medium can include computer readable storage medium distributed over a network-coupled computer system so that the computer readable code is stored and executed in a distributed fashion.

Further, for method operations that were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

What is claimed is:

1. A sled assembly for a storage array, comprising,
a first rail extending between a first end and a second end;
a second rail extending between the first end and the second end, the second rail being parallel to the first rail;
an ejector body coupled to the first rail and the second rail at the first end;
a first drive guide having a first pair of channels, the first drive guide disposed adjacent to and parallel to the first rail and interfaced with the ejector body at the first end; and
a second drive guide having a second pair of channels, the second drive guide disposed adjacent to and parallel to the second rail and interfaced with the ejector body at the first end;
wherein a first drive and a second drive are configured to be disposed between the first rail and the second rail and respectively enabled to slide into and out of the sled assembly, the sled assembly is further enabled to slide into and out of the storage array.

2. The sled assembly of claim 1, further comprising,
an internal drive assembly for receiving one of the first drive or the second drive, the internal drive assembly including,
a first sub-rail;
a second sub-rail disposed parallel to the first sub-rail;
a sub-ejector body coupled to the first and second sub-rails; and
a frame base, the first or second drive being received between the first and second sub-rails and the frame base;
wherein the first sub-rail and the second sub-rail of the internal drive assembly is configured to slide along one of the first or second drive guides of the sled assembly.

3. The sled assembly of claim 1, further comprising,
an ejector handle coupled to the ejector body, the ejector handle including a button to release the ejector handle, wherein the ejector handle is configured to pivot about a hinge, wherein when the ejector handle is opened to pivot about the hinge a lever enables release of the sled assembly from the storage array.

4. The sled assembly of claim 1, further comprising,
a paddle card fixed to a back end of the first and second drive guides, the paddle card having an internal side facing toward the first end and an external side facing toward the second end.

5. The sled assembly of claim 4, further comprising,
a first sled connector disposed on the internal side of the paddle card;
a second sled connector disposed on the internal side of the paddle card, the second sled connector being parallel to the first sled connector,
wherein the first sled connector is configured to align with a first channel of the first and second pair of channels and the second sled connector is configured to align with a second channel of the first and second pair of channels, respectively of the first and second drive guides;
wherein the first and second sled connectors provide connection to drive connectors of internal drives when disposed in the sled assembly.

6. The sled assembly of claim 5, further comprising,
a third sled connector disposed on the external side of the paddle card, the third connector providing an interface for the sled assembly with a back plane connector of a storage controller of the storage array.

7. The sled assembly of claim 6, wherein the paddle card is defined by a printed circuit board (PCB) having a bridge circuit, the bridge circuit is configured to provide a link between the third sled connector that provides interface using a first protocol and the first and second sled connectors that provide interface using a second protocol.

8. The sled assembly of claim 7, wherein the PCB that includes the bridge circuit further includes a first switch and a second switch interfaced with the first and second sled connectors with a hot swap circuit, the hot swap circuit further interfaced with the third sled connector, the hot swap circuit providing signaling data to enable independent removal or insertion of one or both of the internal drives without removal of the sled assembly from the storage array.

9. The sled assembly of claim 7, wherein the PCB that includes the bridge circuit further includes status indicators interfaced with the bridge circuit, the status indicators being for the internal drives when disposed in the sled assembly.

10. The sled assembly of claim 7, wherein the bridge circuit is configured to translate communication between the first protocol and the second protocol and the second protocol and the first protocol.

11. The sled assembly of claim 7,
wherein the first protocol is a serial attached SCSI (SAS) protocol and the second protocol is a serial AT attachment (SATA) protocol, and wherein the bridge circuit interfaces with the third sled connector via a first and a second SAS port and the bridge circuit interfaces with the first and second sled connectors, respectively via a first SATA port and a second SATA port; or
wherein the first protocol and the second protocol is based on a non-volatile express (NVME) protocol, and a switch circuit is disposed between connectors that interface between the first and second protocols.

12. The sled assembly of claim 1, wherein the storage array includes an array of said sled assemblies.

13. The sled assembly of claim 12, wherein the array of sled assembles include one of,
(1) a 1U array having one row that includes four sled assemblies, each sled assembly is configured to hold two internal drives; (2) a 2U array having two rows, each row includes four sled assemblies, each sled assembly is configured to hold two internal drives; (3) a 3U array having three rows, each row includes four sled assemblies, each sled assembly is configured to hold two internal drives; (4) a 4U array having four rows, each row includes four sled assemblies, each sled assembly is configured to hold two internal drives; or (5) a NU array having N rows, each row includes four sled assemblies, each sled assembly is configured to hold two internal drives.

14. A sled assembly for a storage array, comprising,
a first rail extending between a first end and a second end;
a second rail extending between the first end and the second end, the second rail being parallel to the first rail;
an ejector body coupled to the first rail and the second rail at the first end;
a first drive guide having a first pair of channels, the first drive guide disposed adjacent to and parallel to the first rail and interfaced with the ejector body at the first end; and
a second drive guide having a second pair of channels, the second drive guide disposed adjacent to and parallel to the second rail and interfaced with the ejector body at the first end;
a first internal drive assembly for receiving a first drive; and
a second internal drive assembly for receiving a second drive;
each of said first and second internal drive assemblies including a first sub-rail and a second sub-rail disposed parallel to the first sub-rail, a sub-ejector body coupled to the first and second sub-rails, and a frame base,
wherein each of said first and second internal drive assemblies enabled to slide in and out of the sled assembly independent of removal of said sled assembly from said storage array.

15. A sled assembly as recited in claim 14,
wherein the first drive is received between the first and second sub-rails and the frame base of the first internal drive assembly;
wherein the second drive is received between the first and second sub-rails and the frame base of the second internal drive assembly.

16. A sled assembly as recited in claim 15, wherein the first sub-rail and the second sub-rail of the first internal drive assembly is configured to slide along a first channel of the first and second drive guides;
wherein the first sub-rail and the second sub-rail of the second internal drive assembly is configured to slide along a second channel of the first and second drive guides.

17. A sled assembly as recited in claim 16, wherein the first drive and the second drive are configured to be disposed between the first rail and the second rail and respectively enabled to slide into and out of the sled assembly, the sled assembly is further enabled to slide into and out of the storage array while holding either the first drive or the second drive, when present in sled assembly.

18. The sled assembly of claim 14, further comprising,
an ejector handle coupled to the ejector body, the ejector handle including a button to release the ejector handle, wherein the ejector handle is configured to pivot about a hinge, wherein when the ejector handle is opened to pivot about the hinge a lever enables release of the sled assembly from the storage array.

19. The sled assembly of claim 14, further comprising,
a paddle card fixed to a back end of the first and second drive guides, the paddle card having an internal side facing toward the first end and an external side facing toward the second end.

20. The sled assembly of claim 14, further comprising,
a first sled connector disposed on the internal side of the paddle card;
a second sled connector disposed on the internal side of the paddle card, the second sled connector being parallel to the first sled connector,
wherein the first sled connector is configured to align with a first channel of the first and second pair of channels and the second sled connector is configured to align with a second channel of the first and second pair of channels, respectively of the first and second drive guides;
wherein the first and second sled connectors provide connection to drive connectors of the first and second drives when disposed in the sled assembly.

21. The sled assembly of claim 20, further comprising,
a third sled connector disposed on the external side of the paddle card, the third connector providing an interface for the sled assembly with a back plane connector of a storage controller of the storage array.

22. The sled assembly of claim 21, wherein the paddle card is defined by a printed circuit board (PCB) having a bridge circuit, the bridge circuit is configured to provide a link between the third sled connector that provide interface using a first protocol and the first and second sled connectors that provide interface using a second protocol.

23. The sled assembly of claim 22, wherein the bridge circuit is configured to translate communication between the first protocol and the second protocol and the second protocol and the first protocol.

24. The sled assembly of claim 22, wherein the first protocol is a serial attached SCSI (SAS) protocol and the second protocol is a serial AT attachment (SATA) protocol, and wherein the bridge circuit interfaces with the third sled connector via a first and a second SAS port and the bridge circuit interfaces with the first and second sled connectors, respectively via a first SATA port and a second SATA port.

25. The sled assembly of claim 14, wherein the storage array includes an array of said sled assemblies, and wherein the array of sled assembles include one of,
(1) a 1U array having one row that includes four sled assemblies, each sled assembly is configured to hold two internal drives; (2) a 2U array having two rows, each row includes four sled assemblies, each sled assembly is configured to hold two internal drives; (3) a 3U array having three rows, each row includes four sled assemblies, each sled assembly is configured to hold two internal drives; (4) a 4U array having four rows, each row includes four sled assemblies, each sled assembly is configured to hold two internal drives; or (5) a NU array having N rows, each row includes four sled assemblies, each sled assembly is configured to hold two internal drives.

26. A sled assembly for a storage array, comprising,
a first rail extending between a first end and a second end;
a second rail extending between the first end and the second end, the second rail being parallel to the first rail;
an ejector body coupled to the first rail and the second rail at the first end;
a first internal drive assembly for receiving a first drive; and
a second internal drive assembly for receiving a second drive, and each of said first and second internal drive assemblies including a first sub-rail and a second sub-rail disposed parallel to the first sub-rail, a sub-ejector body coupled to the first and second sub-rails, and a frame base; and
a paddle card disposed between the first rail and the second rail, the paddle card having an internal side facing toward the first end and an external side facing toward the second end, and a first sled connector disposed on the internal side of the paddle card, a second sled connector disposed on the internal side of the paddle card, the second sled connector being parallel to the first sled connector, wherein the first and second sled connectors provide connection to drive connectors of the first and second drives when disposed in the sled assembly, and a third sled connector disposed on the external side of the paddle card, the third connector providing an interface for the sled assembly with a connector of a storage controller of the storage array
wherein each of said first and second internal drive assemblies enabled to slide in and out of the sled assembly independent of removal of said sled assembly from said storage array.

27. The sled assembly of claim 26, wherein the paddle card is defined by a printed circuit board (PCB) having a bridge circuit, the bridge circuit is configured to provide a link between the third sled connector that provides interface using a first protocol and the first and second sled connectors that provide interface using a second protocol.

28. The sled assembly of claim 27, wherein the bridge circuit is configured to translate communication between the first protocol and the second protocol and the second protocol and the first protocol.

29. The sled assembly of claim 27, wherein the first protocol is a serial attached SCSI (SAS) protocol and the second protocol is a serial AT attachment (SATA) protocol, and wherein the bridge circuit interfaces with the third sled connector via a first and a second SAS port and the bridge circuit interfaces with the first and second sled connectors, respectively via a first SATA port and a second SATA port.

30. The sled assembly of claim 26, wherein the storage array includes an array of sled assembles that include one of,
(1) a 1U array having one row that includes four sled assemblies, each sled assembly is configured to hold two internal drives; (2) a 2U array having two rows, each row includes four sled assemblies, each sled assembly is configured to hold two internal drives; (3) a 3U array having three rows, each row includes four sled assemblies, each sled assembly is configured to hold two internal drives; (4) a 4U array having four rows, each row includes four sled assemblies, each sled assembly is configured to hold two internal drives; or (5) a NU array having N rows, each row includes four sled assemblies, each sled assembly is configured to hold two internal drives.
